(19) United States
(12) Patent Application Publication
(10) Pub. No.: US 2008/0290811 A1
(43) Pub. Date: Nov. 27, 2008

(54) POWER SOURCE UNIT FOR DISCHARGE LAMP AND METHOD OF CONTROLLING THE SAME

(75) Inventor: Akira YOSHIDA, Saitama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/935,785

(22) Filed: Nov. 6, 2007

(30) Foreign Application Priority Data
Dec. 21, 2006 (JP) 2006-344968

(51) Int. Cl. H05B 37/02

(52) U.S. Cl. 315/225

(57) ABSTRACT

A switching element is switched at a high frequency in accordance with control by a pulse generating circuit by using a D.C. power source portion as a power source, which results in that a discharge lamp is driven with a D.C. current through a smoothing circuit. A current detecting resistor detects the lamp current caused to flow through the discharge lamp, a current controlling circuit amplifies a deviation between the detected lamp current value and a preset current reference value, and the resulting value is applied to a feedback terminal (F/B) of the pulse generating circuit through a gain setting circuit. A gain changing circuit changes a loop gain of a feedback control system including the switching element, the smoothing circuit, the discharge lamp, and the pulse generating circuit at an output point of the gain setting circuit in correspondence to a fluctuation in a power source voltage (Vₚ) from the D.C. power source portion.

The present application claims priority from Japanese patent application No. 2006-344968, filed Dec. 26, 2006, the entire contents of which are incorporated herein by reference.

### BACKGROUND

1. Field

One embodiment of the invention relates to a power source unit for a discharge lamp which is used in a projection type image displaying apparatus or the like using a discharge lamp as a light source, and a method of controlling the same.

2. Description of the Related Art

An image displaying apparatus utilizing a color-sequential system including digital light processing (DLP: a registered trademark of Texas Instruments Inc.) using a digital micromirror device (DMD: a registered trademark of Texas Instruments Inc.) is known as one of image displaying apparatuses. The image displaying apparatus utilizing this color-sequential system is constructed such that color filters which have filters of the three primary colors having red (R), green (G) and blue (B) and which are adapted to rotate, a condenser lens, a DMD, a projection lens are disposed in order on an optical path between a light source lamp and a screen. The image displaying apparatus utilizing the color-sequential system, for example, is disclosed in the Japanese Patent Kokai No. 2000-231066, and the Japanese Patent No. 3797342.

A discharge lamp is generally used as a light source in the image displaying apparatus utilizing the color-sequential system. The discharge lamp is driven by a power source unit for a discharge lamp including a D.C. power source, a switching element for switching a D.C. voltage generated by the D.C. power source, and a smoothing circuit for smoothing an output current from the switching element, and supplying the resulting smoothed current to the discharge lamp.

On the other hand, the lamp current to be supplied to the discharge lamp is reduced at a specific timing as compared with a stationary current, and the resulting lamp current is outputted in some cases. In general, the discharge lamp has such an emission spectrum that a green (G) component shows a stronger intensity than that of each of a red (R) component and a blue (B) component. In this case, in order to balance the green component with other red and blue components having respective wavelength bands, there is performed the control for reducing a quantity of light emitted from the discharge lamp from one in a stationary state at a timing at which a G light from a corresponding color filter passes through an optical path.

When the control for reducing the quantity of light is performed in the manner as described above, a current transition occurs when the lamp current is changed in order of a stationary state→a reduction state→a stationary state. However, since a lamp light corresponding in timing to the current transition portion cannot be utilized for image display, a period of time (a period of time for a current transition) required for the current transition, that is, a period of time for which the lamp current is in the unstable state when being changed from a certain stable state to a next stable state, specifically, a period of time for which an overshoot or an undershoot is easy to occur must be shortened as much as possible. The period of time required for the current transition depends on a loop gain of the switching element, the smoothing circuit, the discharge lamp, lamp current-detecting means, a control system for the switching element, and the switching element. Thus, in order to shorten the period of time required for the current transition, the loop gain must be set at an optimal value.

However, according to the conventional power source unit for a discharge lamp, a nonconformity occurs in which when a voltage of a commercial power source fluctuates, an output voltage from a D.C. power source fluctuates accordingly, and the loop gain of the lamp current control loop also fluctuates, which results in that a waveform disturbance such as a vibration or a waveform rounding occurs in each of the lamp current transition portions, so that a bad influence is exerted on a quality of luminance linearity of a displayed image.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view showing a construction of an image displaying apparatus according to a first embodiment of the invention;

FIG. 2 is an exemplary circuit diagram showing a detailed circuit structure of a power source unit for a discharge lamp in the image displaying apparatus according to the first embodiment of the invention;

FIG. 3A is an exemplary schematic timing chart showing colors of lights from a color wheel in operations of respective portions in the power source unit for a discharge lamp shown in FIG. 2;

FIG. 3B is an exemplary schematic timing chart showing a timing at which a small lamp current is caused to flow through the discharge lamp only for a period of time for a small lamp current in the operations of the respective portions in the power source unit for a discharge lamp shown in FIG. 2;

FIG. 3C is an exemplary schematic timing chart showing an operation mode of a gain setting circuit in the operations of the respective portions in the power source unit for a discharge lamp shown in FIG. 2;

FIG. 3D is an exemplary schematic timing chart showing a duty in a pulse generating circuit in the operations of the respective portions in the power source unit for a discharge lamp shown in FIG. 2;

FIG. 4A is an exemplary waveform chart, when a loop gain is too large, showing a situation in which a period of time required for a current transition changes depending on a magnitude of the loop gain;

FIG. 4B is an exemplary waveform chart, when a loop gain is optimal, showing the situation in which the period of time required for the current transition changes depending on the magnitude of the loop gain;

FIG. 4C is an exemplary waveform chart, when a loop gain is too small, showing the situation in which the period of time required for the current transition changes depending on the magnitude of the loop gain;

FIG. 5A is an exemplary waveform chart showing a change in duty of a switching element when the duty is changed;

FIG. 5B is an exemplary waveform chart showing a change in output current of the switching element and a change in average current caused to flow through the discharge lamp when the duty is changed;

FIG. 6A is an exemplary waveform chart showing a change in duty of the switching element when the duty is changed to a value different from that in FIGS. 5A and 5B;

FIG. 6B is an exemplary waveform chart showing a change in output current of the switching element and a change in average current caused to flow through the discharge lamp when the duty is changed to the value different from that in FIGS. 5A and 5B;

FIG. 7 is an exemplary timing chart showing a gain changing operation of a gain changing circuit;

FIG. 8 is an exemplary timing chart showing another gain changing operation of the gain changing circuit; and

FIG. 9 is an exemplary circuit diagram showing a detailed circuit structure of a power source unit for a discharge lamp in an image displaying apparatus according to a second embodiment of the invention.

### DETAILED DESCRIPTION OF PREFERRED EMBODIMENTS

Various embodiments according to the invention will be described hereinafter with reference to the accompanying drawings. In general, according to one embodiment of the invention, there is provided a power source unit for a discharge lamp, including: a switching element for switching-driving the discharge lamp by using a D.C. power source as a power source; a feedback control system for controlling the switching element in accordance with a detected lamp current value and a current command for the discharge lamp; and gain changing means for changing a loop gain of the feedback control system in correspondence to a voltage fluctuation in the D.C. power source.

According to the constitution as described above, the gain changing means changes the loop gain of the feedback control system in correspondence to the voltage fluctuation in the D.C. power source, so that the fluctuation in the loop gain is suppressed, thereby preventing a waveform disturbance from occurring in each of lamp current transition portions.

In addition, according to a further embodiment of the invention, there is provided a power source unit for a discharge lamp, including: a switching element for driving the discharge lamp by using a D.C. power source as a power source; a smoothing circuit for smoothing an output from the switching element, and supplying the output thus smoothed to the discharge lamp; current detecting means for detecting a current which is caused to flow through the discharge lamp; a pulse generating circuit for switching the switching element at a high frequency in accordance with a difference between a preset current reference value and a value detected by the current detecting means; and a gain changing circuit for changing a loop gain of a feedback control system including the switching element, the smoothing circuit, the discharge lamp, the current detecting means and the pulse generating circuit in correspondence to a voltage fluctuation in the D.C. power source.

According to the constitution as described above, the gain changing circuit changes the loop gain of the feedback control system in correspondence to the voltage fluctuation in the D.C. power source, so that the fluctuation in the loop gain is suppressed, thereby preventing a waveform disturbance from occurring in each of lamp current transition portions.

In addition, according to a still further embodiment of the invention, there is provided a method of controlling a discharge lamp, including the steps of: switching-driving the discharge lamp by a switching element by using a D.C. power source as a power source; controlling the switching element by a feedback control system in accordance with a detected lamp current value and a current command for the discharge lamp; and changing a loop gain of the feedback control system in correspondence to a voltage fluctuation in the D.C. power source.

According to the control method as described above, the loop gain of the feedback control system is changed in correspondence to the voltage fluctuation in the D.C. power source, so that the fluctuation in the loop gain is suppressed, thereby preventing a waveform disturbance from occurring in each of lamp current transition portions.

According to the power source unit for a discharge lamp and the method of controlling the same, the waveform disturbance can be prevented from occurring in each of lamp current transition portions irrespective of the fluctuation in the D.C. power source voltage.

### FIRST EMBODIMENT

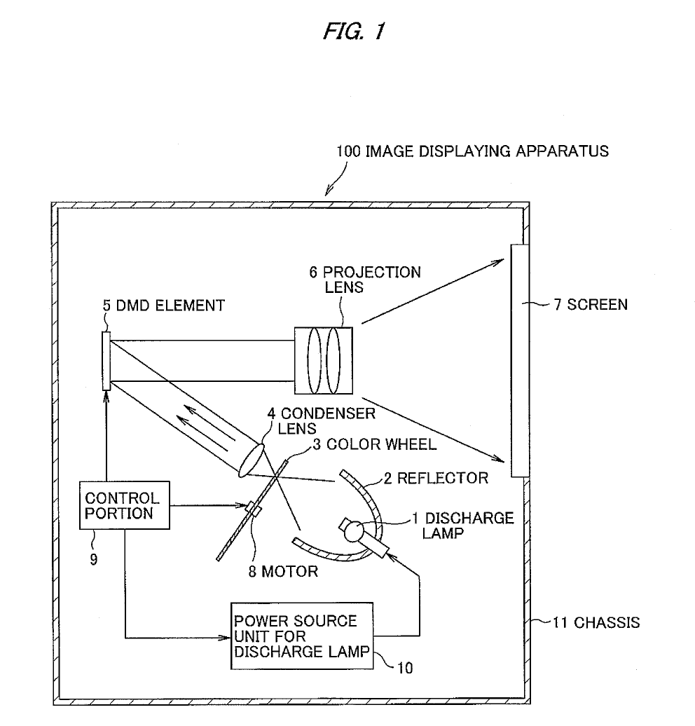

FIG. 1 shows an image displaying apparatus according to a first embodiment of the invention. The image displaying apparatus 100 includes a discharge lamp 1 as a light source for emitting a white light, a reflector 2 for reflecting the white light emitted from the discharge lamp 1 in a predetermined direction, a color wheel 3 including filters having the three primary colors R, G and B, a condenser lens 4 for converting the light from the color wheel 3 into a parallel light, a DMD element 5 for selecting the lights obtained through the condenser lens 4, and outputting the resulting optimal image in a projection direction, a projection lens 6 for projecting the optical image from the DMD element 5 on a projection surface of a screen 7, the screen 7 having the projection surface on which the optical image through the projection lens 6 is projected, a motor 8 for rotation-driving the color wheel 3, a control portion 9 for controlling the DMD element 5 and the motor 8, a power source unit 10 for a discharge lamp for controlling light emission of the discharge lamp 1 under the control by the controller 9, and a chassis 11 which accommodates therein all the portions described above and in which the screen 7 is installed so as to be visible from the outside.

For example, a short-arc lamp, an ultra-high pressure type mercury lamp, a metal halide lamp or the like can be used as the discharge lamp 1.

The reflector 2, for example, is mounted integrally with the discharge lamp 1 and is normally formed in elliptical shape. In addition, the reflector 2 condenses the light emitted from the discharge lamp 1 and focuses the light thus condensed on the color wheel 3.

The color wheel 3 is rotated at a high speed by the motor 8 rotatably mounted to the color wheel 3, so that the color of the light made incident to the DMD element 5 is changed from R to B through G in order. Thus, the image in accordance with the color corresponding to the illumination light emitted on the optical path is displayed on the DMD element 5, thereby making it possible to represent the image having the color concerned. In general, the color wheel 3 adopted a six-segment system in which segments of R, G, B, and R, G, B are disposed in order at intervals of 60° on the same circumference.

The DMD element 5 is formed in one sheet of panel by, for example, spreading about 800,000 fine mirror elements all over a semiconductor element having a size of 17 mm×13 mm. These fine mirror elements are mounted to one or more hinges disposed in a post so as to be each movable within the range of about ±10. That is to say, in the DMD element 5, one fine mirror element corresponds to one pixel. The DMD element 5 operates so that when one fine mirror element of the DMD element 5, for example, is inclined at an angle of +10°, the light emitted from the discharge lamp 1 is reflected by the one fine mirror element of the DMD element 5 to be made incident to the projection lens 6, while one fine mirror element of the DMD element 5, for example, is inclined at the angle of −10°, no reflected light is made incident to the projection lens 6.

The control portion 9 includes a CPU, a ROM, a RAM, an image memory and the like. Also, the control portion 9 includes a configuration and software for rotating the color wheel 3, controlling the driving of the corresponding ones of the fine mirror elements of the DMD elements 5 at individual timings at which the color filters of the color wheel 3 are successively interposed on the optical path in accordance with the image data stored in the image memory or taken therein from the outside, and controlling the lamp current which is caused to flow through the discharge lamp 1 by operation of the power source unit 10.

### [Operation of Image Displaying Apparatus]

Next, an operation of the image displaying apparatus 100 shown in FIG. 1 will now be described.

When the control portion 9 and the power source unit 10 for a discharge lamp operate to rotate the motor 8 and to turn ON the discharge lamp 1, the light emitted from the discharge lamp 1 reaches the color wheel 3 to be separated in color into R, G and B in this order in accordance with the rotation of the color wheel 3.

The condenser lens 4 converts the color light emitted from the color wheel 3 to the optical path into the parallel light which is in turn radiated to the DMD element 5. In the DMD element 5, the corresponding ones of the fine mirror elements reflect the R, G or B light made incident thereto in accordance with image data under the control by the control portion 9. The color light reflected by the DMD element 5 reaches the projection lens 6, and is then projected on the projection surface of the screen 7 by the projection lens 6.

Although the R, G and B images are successively projected and displayed on the projection surface of the screen 7 by the projection lens 6, they are switched over to one another at a high frequency. Hence, a viewer who enjoys the image on the screen 7 perceives the image as one in which R, G and B are mixed with one another. As a result, the color image can be obtained.

### [Structure of Power Source Unit for Discharge Lamp]

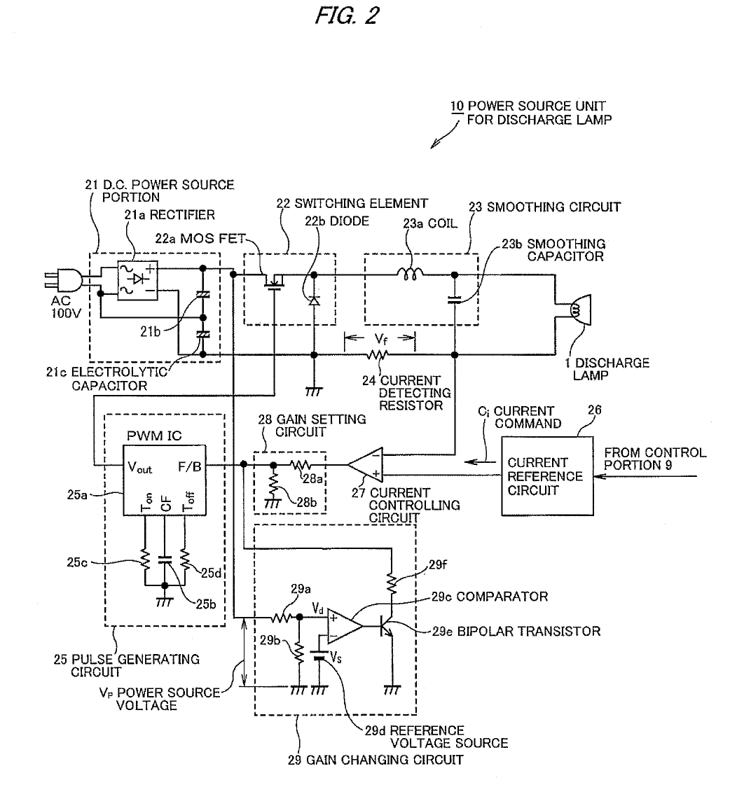

FIG. 2 shows a detailed circuit structure of the power source unit 10 for a discharge lamp. The power source unit 10 for a discharge lamp includes a D.C. power source portion 21, a switching element 22 connected to the D.C. power source portion 21, a smoothing circuit 23 for smoothing an output current from the switching element 22, a current detecting resistor 24 which serves as current detecting means and which is connected between a negative polarity terminal of the D.C. power source portion 21 and a low potential side of the discharge lamp 1, a pulse generating circuit 25 for controlling the switching element 22 in accordance with a pulse width modulation (PWM) system, a current reference circuit 26 for outputting a current command Cᵢ in accordance with which a value of a lamp current to be caused to flow through the discharge lamp 1 is determined under the management by the control portion 9, a current controlling circuit 27 for outputting a deviation value between the current command Cᵢ and a detected voltage V_{f} developed across the current detecting resistor 24, a gain setting circuit 28 for setting an output voltage from the current controlling circuit 27 at a predetermined level, and outputting the resulting voltage to the pulse generating circuit 25, and a gain changing circuit 29, as gain changing means, for changing a level of an output from the gain setting circuit 28 to another one in correspondence to an output fluctuation in the D.C. power source portion 21.

The D.C. power source portion 21 includes a full-wave voltage doubler-rectifying circuit having a rectifier 21a for full-wave-rectifying an A.C. voltage from a commercial power source, and electrolytic capacitors 21b and 21c. Also, the D.C. power source portion 21, for example, generates a D.C. voltage of about 250 to about 370 V from the commercial power source of about A.C. 90 to about A.C. 132 V. Note that, while being omitted in illustration, a power source circuit for supplying a suitable D.C. voltage to each of the individual circuits is specially prepared for.

The switching element 22 includes an N-channel metal oxide semiconductor (MOS) field effect transistor (FET) 22a for switching, and a diode 22b through which an electrical energy accumulated in the smoothing circuit 23 in an OFF phase of the N-channel MOSFET 22a is caused to pass.

The smoothing circuit 23 includes a coil 23a connected between the switching element 22 and the discharge lamp 1, and a smoothing capacitor 23b connected in parallel with the discharge lamp 1.

The pulse generating circuit 25 includes a PWMIC 25a, a capacitor 25b connected to an oscillation capacitance terminal CF of the PWMIC 25a, and resistors 25c and 25d connected to an oscillation resistance terminals Tₒₙ and T_{off}, respectively. The suitable selection of a capacitance value of the capacitor 25b, and resistance values of the resistors 25c and 25d determines an oscillation frequency of a triangular oscillation waveform of the pulse. More specifically, an inclination of an up-grade of the triangular oscillation waveform of the pulse depends on the product of the capacitance value of the capacitor 25b and the resistance value of the resistor 25c, while an inclination of a down-grade of the triangular oscillation waveform thereof depends on the product of the capacitance value of the capacitor 25b and the resistance value of the resistor 25d.

The current controlling circuit 27 includes an operational amplifier which receives as its inputs the detected value V_{f} developed across the current detecting resistor 24, and the current command Cᵢ.

The gain setting circuit 28 is connected in series between an output terminal of the current controlling circuit 27 and the earth, and includes resistors 28a and 28b for resistance-dividing an output voltage from the current controlling circuit 27, and outputting the resulting voltage to a feedback terminal F/B of the PWMIC 25a.

The gain changing circuit 29 includes resistors 29a and 29b for resistance-dividing a power source voltage Vₚ of the D.C. power source portion 21, a comparator 29c which operates in accordance with a difference between the power source voltage Vₚ a reference voltage Vₛ, a reference voltage source 29d for outputting the reference voltage Vₛ, an NPN transistor 29e which operates in accordance with an output voltage from the comparator 29c, and a resistor 29f connected between a collector of the NPN transistor 29e and the feedback terminal F/B of the PWMIC 25a.

### [Operation of Power Source Unit for Discharge Lamp]

Next, an operation of the power source unit 10 for a discharge lamp will now be described.

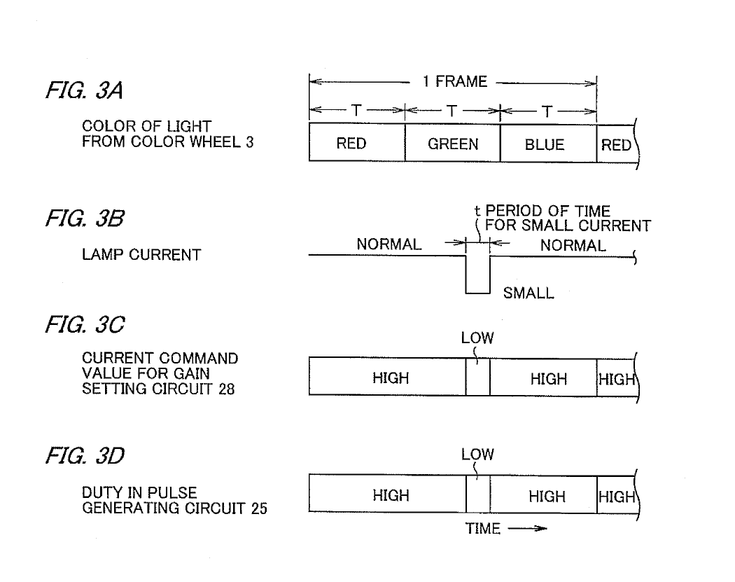

FIGS. 3A to 3D are respectively timing charts showing operations of the respective portions of the power source unit for a discharge lamp. In these timing charts of FIGS. 3A to 3D, FIG. 3A shows the lights which are successively transmitted through the color wheel 3 to have the three primary colors R, G and B, respectively, FIG. 3B shows a timing at which a lamp current is caused to flow through the discharge lamp 1 only for a period of time for a small lamp current, FIG. 3C shows an operation mode of the gain setting circuit 28, and FIG. 3D shows an operation mode of the pulse generating circuit 25. Here, a period, 3T, of time having a combination of three periods, T, of time for the three primary colors R, G and B shown in FIG. 3A, respectively, corresponds to one frame of a color image.

The power source voltage Vₚ outputted from the D.C. power source portion 21 is applied to the switching element 22. The switching element 22 is PWM-controlled in accordance with the control by the pulse generating circuit 25 which operates at a predetermined frequency (for example, 70 kHz) and with a set current value, so that a current having a rectangular waveform is supplied to the smoothing circuit 23 to be smoothed thereby. Also, the current smoothed by the smoothing circuit 23 is caused to flow through the discharge lamp 1 to turn ON the discharge lamp 1.

A voltage drop (detected voltage V_{f}) is developed across the current detecting resistor 24 by causing the smoothed current to flow through the discharge lamp 1, and the detected voltage V_{f} is then inputted to an inverted input terminal of the current controlling circuit 27. The current controlling circuit 27 generates such an output voltage that a voltage to be inputted to the feedback terminal F/B of the pulse generating circuit 25 gets a constant value in accordance with a difference between the detected voltage V_{f} and the value of the current command Cᵢ inputted from the current changing circuit 26 to a non-inverted input terminal of the current controlling circuit 27.

When it, as shown in FIG. 3A, becomes the period, T, of time for which the green light is made incident to the corresponding ones of the fine mirror elements of the DMD element 5 with the rotation of the color wheel 3, the current reference circuit 26 changes the current command Cᵢ only for a partial period, t, of time (a period of time for a small lamp current) within the period, T, of time, and reduces the output voltage from the gain setting circuit 28 for the period, t, of time as shown in FIG. 3C, and under this condition, controls the pulse generating circuit 25. As a result, since a duty in the pulse generating circuit 25 is held low only for the partial period, t, of time as shown in FIG. 3D, the lamp current which is caused to flow through the discharge lamp 1 is reduced only for the partial period, t, of time as shown in FIG. 3B, so that an emission output, of the discharge lamp 1, for display of a green image.

Here, the loop gain of the feedback control system will now be described.

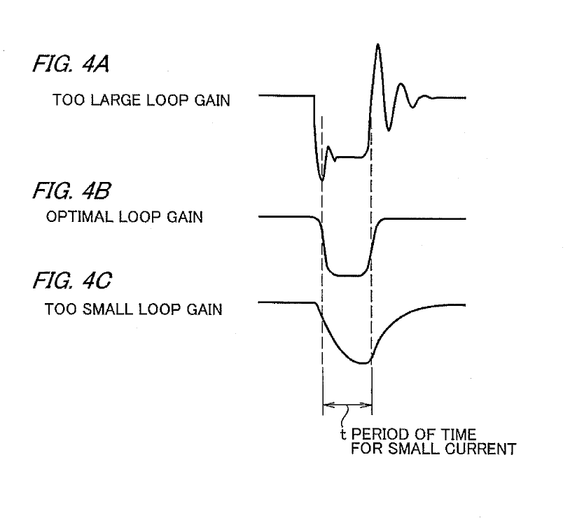

FIGS. 4A to 4C show a situation in which the period of time required for the current transition changes depending on the magnitude of the loop gain. That is to say, FIG. 4A shows a waveform of the lamp current when the loop gain is too large, FIG. 4B shows a waveform of the lamp current when the loop gain is optimal (the period of time required for the current transition is 200 psec.), and FIG. 4C shows a waveform of the lamp current when the loop gain is too small. As described above, the period of time required for the current transition depends on the loop gain G in the feedback control system from the current controlling circuit 27 which operates in accordance with the detected voltage V_{f} developed across the current detecting resistor 24 to the switching element 22.

As apparent from FIGS. 4A and 4C, when the loop gain is too large, a vibration occurs in each of current transition portions, while when the loop gain is too small, a waveform rounding occurs in each of the current transition portions. In each of these cases shown in FIGS. 4A and 4C, a period of time required for the current transition is lengthened as compared with that in a state in which the optimal loop gain G is obtained as shown in FIG. 4B.

Here, the loop gain G (A/sec.) of the feedback control system including the switching element 22, the smoothing circuit 23, the discharge lamp 1, the current detecting resistor 24, the current controlling circuit 27, the gain setting circuit 28 and the pulse generating circuit 25 is expressed by Expression (1):

G=G1×G2×G3 . . . (1)

where G1 (V/A) is a gain determined by the gain changing circuit 29, G2 (A/%·sec.) is a gain determined by the smoothing circuit 23, and G3 (%/V) is a gain determined by the pulse generating circuit 25.

In the smoothing circuit 23, for a period of time for which the smoothing element 22 is held in an ON state, the output voltage +Vₚ from the D.C. power source portion 21 is applied to the switching element 22, while for a period of time for which the smoothing element 22 is held in an OFF state, the output voltage −Vₚ from the D.C. power source portion 21 is applied to the switching element 22. In addition, a voltage, on the discharge lamp 1 side, of the smoothing circuit 23 is held at a lamp voltage Vₗₐₘₚ across the discharge lamp 1.

That is to say, while the switching element 22 is held in the ON state, a voltage Vₒₙ expressed by Expression (2) is applied across the coil 23a:

Vₒₙ=(Vₚ−Vₗₐₘₚ) . . . (2)

On the other hand, while the switching element 22 is held in the OFF state, a voltage V_{off} expressed by Expression (3) is applied across the coil 23a:

V_{off}=(−Vₚ-Vₗₐₘₚ)=−(Vₚ+Vₗₐₘₚ) . . . (3)

Here, the lamp voltage Vₗₐₘₚ is a constant voltage which is determined depending on a lamp temperature irrespective of the magnitude of the lamp current. In addition, a forward drop voltage V_{d} across the diode 22b is a constant voltage of about 0.7 V in the case of a silicon diode. Consequently, both Vₗₐₘₚ and V_{d} can be regarded as constants, respectively.

As can be seen from Expressions (2) and (3), since the voltage Vₒₙ across the coil 23a while the switching element 22 is held in the ON state is a function of the power source voltage Vₚ, it changes due to a fluctuation in the power source voltage Vₚ. As a result, a rate of change in current caused to flow through the coil 23a fluctuates depending on the fluctuation in the power source voltage Vₚ, so that the gain G2 determined by the smoothing circuit 23 is necessarily influenced by the power source voltage Vₚ.

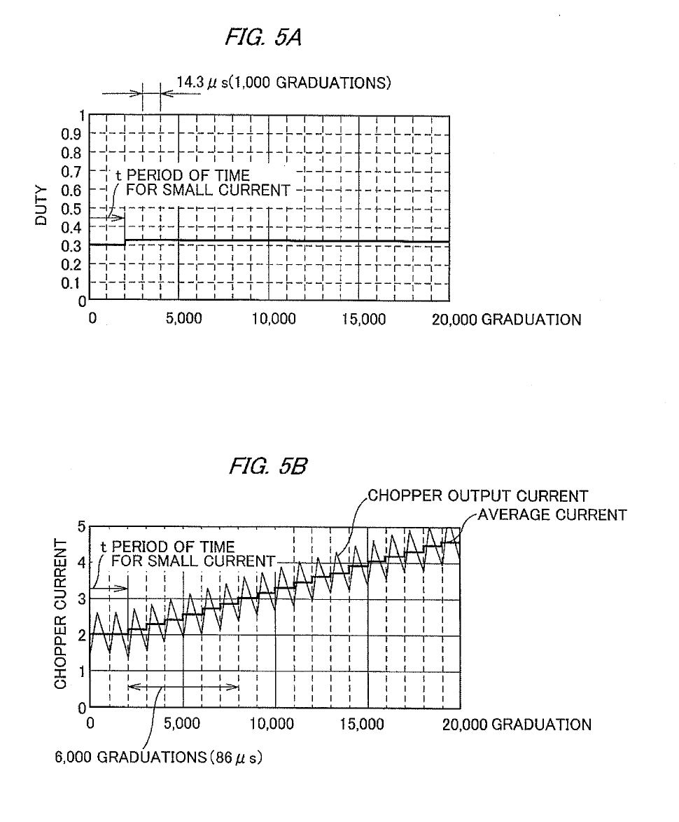

FIGS. 5A and 5B show a change in duty, a change in switching output current and a change in lamp current, respectively, when the duty is changed. That is to say, FIG. 5A shows a change in duty, and FIG. 5B shows a change in output current from the switching element, and a change in average current caused to flow through the discharge lamp. Also, FIGS. 5A and 5B show the case where the power source voltage Vₚ is set as 250 V, and the duty for the ON period of time is increased from 0.3 (30%) to 0.329 (32.5%) by 0.025 (2.5%).

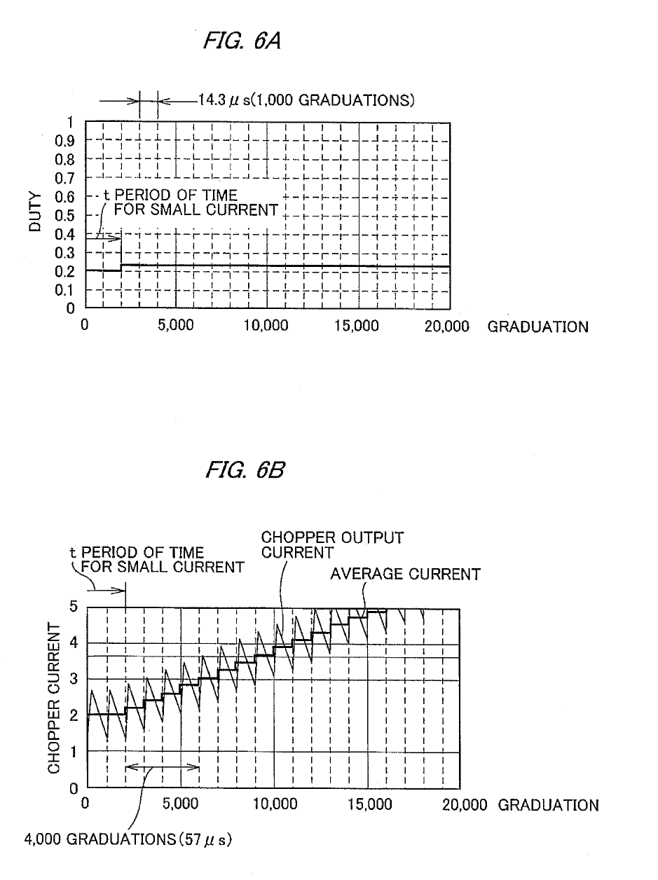

FIGS. 6A and 6B show a change in duty, and a change in switching output current and a change in lamp current, respectively, when the duty is changed to a value different from that in the case of FIGS. 5A and 5B. That is to say, FIG. 6A shows a change in duty, and FIG. 6B shows a change in output current from the switching element and a change in average current caused to flow through the discharge lamp. Also, FIGS. 6A and 6B show the case where the power source voltage Vₚ is set as 370 V, and the duty for the ON period of time is increased from 0.203 (20.3%) to 0.228 (22.8%) by 0.025 (2.5%). Note that, an axis of abscissa in each of FIGS. 5A and 5B, and FIGS. 6A and 6B represents one period of 70 kHz, that is, 14.3 μsec. as 1,000 graduations.

The characteristics shown in FIGS. 5A and 5B, and FIGS. 6A and 6B were measured under the condition that an inductance of the coil 23a was set as 700 pH, an output pulse frequency of the pulse generating circuit 25 was set as 70 kHz, an initial current of the discharge lamp 1 was set as 2 A, and the lamp voltage was set as 75 V.

As shown in FIG. 5B and FIG. 6B, the switching element 22 repeats the ON state and the OFF state with 70 kHz period, and the current which is supplied to the discharge lamp 1 through the smoothing circuit 23 has a rectangular waveform having the period of 70 kHz.

When the duty is changed at the timing shown in FIG. 5A, as shown in FIG. 5B, the lamp current takes 6,000 graduations (86 μsec.) to increase from 2 A to 3A. In addition, when the duty is changed at the timing shown in FIG. 6A, as shown in FIG. 6B, the lamp current takes 4,000 graduations (57 μsec.) to increase from 2 A to 3A.

Referring now to FIGS. 6A and 6B, when the duty for the ON period of time is changed by +2.5% with 2,000 graduations, the lamp current begins to increase. However, calculating the gain G2 determined by the smoothing circuit 23 from an amount of current increased, when the power source voltage Vₚ=250 V shown in FIGS. 5A and 5B, the gain G2 is obtained as follows:

$$\begin{matrix}1 / ( 86 µ sec . \times 2.5 \% ) = {10}^{6} ( 86 \times 2.5 ) \\ = {10}^{6} / 215 \\ \approx 4651 ( A / \% \cdot sec )\end{matrix}$$

On the other hand, when the power source voltage Vₚ=370 V shown in FIGS. 6A and 6B, the gain G2 is obtained as follows:

$$\begin{matrix}1 / ( 57 µ sec . \times 2.5 \% ) = {10}^{6} ( 57 \times 2.5 ) \\ = {10}^{6} / 142.5 \\ \approx 7018 ( A / \% \cdot sec )\end{matrix}$$

Thus, the gain G2 changes in conjunction with the fluctuation in the power source voltage Vₚ.

The fluctuation in the power source voltage Vₚ as the output from the D.C. power source portion 21 follows the fluctuation in the commercial power source voltage (A.C. 100 V), and the gain G2 determined by the smoothing circuit 23 fluctuates in conjunction with the fluctuation in the power source voltage Vₚ. As a result, the loop gain G also fluctuates. Thus, the loop gain G shifts from the optimal state shown in FIG. 3B with the fluctuation of the commercial power source voltage, so that the waveform disturbance occurs in each of the current transition portions as shown in FIG. 4A or 4C. In order to solve this problem, in this embodiment, the gain changing circuit 29 changes an error amplification gain G4, that is, a level of the signal applied to the feedback terminal F/B of the pulse generating circuit 25 in correspondence to the fluctuation in the power source voltage Vₚ.

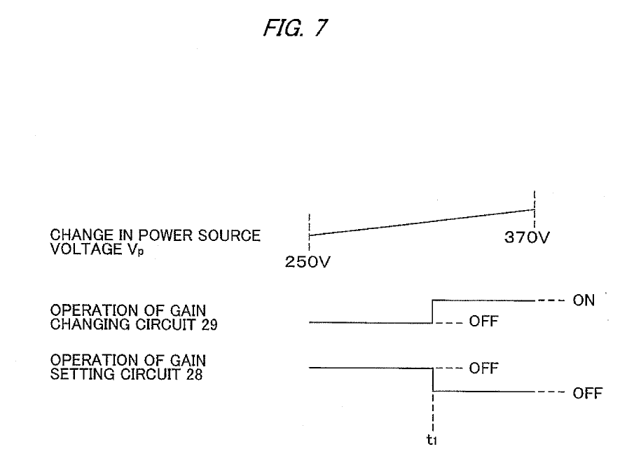

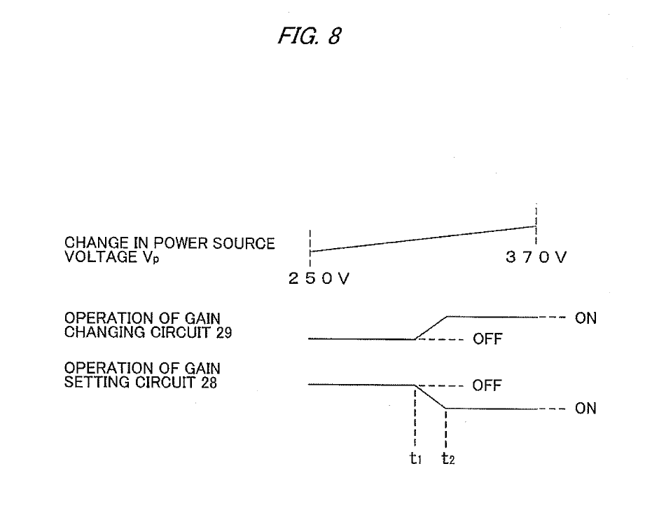

FIG. 7 shows one gain changing operation of the gain changing circuit 29, and FIG. 8 shows another gain changing operation of the gain changing circuit 29.

As shown in FIG. 7, when the power source voltage Vₚ increases, so that it becomes time t₁ for the voltage V_{d} at a node between the resistors 29a and 29b to exceed the reference voltage Vₛ of the reference voltage source 29d, the comparator 29c outputs the output voltage, thereby turning ON the NPN transistor 29e. Turn-ON of the NPN transistor 29e results in that the resistor 29f is connected in parallel with the resistor 28b. Thus, the voltage which is applied to the feedback terminal F/B of the pulse generating circuit 25 is reduced, that is, the error amplification gain G4 is reduced at and after a time point of time t₁. Here, when the power source voltage Vₚ turns to a drop mode to become equal to or smaller than the reference voltage Vₛ, the comparator 29c outputs no output voltage to turn OFF the NPN transistor 29e, so that the error amplification gain G4 is returned back to an original value.

Note that, although the gain changing circuit 29 shown in FIG. 2, as shown in FIG. 7, has a structure with which the error amplification gain G4 of the NPN transistor 29e changes in a binary form, as shown in FIG. 8, it may also have a structure with which the error amplification gain G4 gradually decreases for a predetermined period of time from time t₁ to time t₂. In order to realize this operation, the comparator 29c must be removed from the gain changing circuit 29 shown in FIG. 2, and the node between the resistors 29a and 29b must be connected to a base of the NPN transistor 29e.

In addition, although the case where the power source voltage Vₚ increases, which results in that the waveform disturbance is easy to occur in each of the current transition portions has been descried so far in the above-mentioned constitution, a constitution which copes with the case where the power source voltage Vₚ drops from 100 V may also be adopted. In this case, the gain changing circuit 29 must be structured such that the reference voltage from the reference voltage source 29d is set as a voltage value lower than 100 V, and when the voltage V_{d} becomes equal to or smaller than this voltage value, the comparator 29c outputs the output voltage. Moreover, the gain changing circuit 29 must be structured such that it is provided with an element with which a resistor is connected in parallel with the resistor 28a through the output voltage from the comparator 29c.

According to the first embodiment of the invention, since the gain changing circuit 29 changes the output from the gain setting circuit 28 in correspondence to the fluctuation in the power source Vₚ, it is possible to prevent the loop gain G from fluctuating due to the fluctuation in the power source Vₚ. As a result, since the loop gain G is held in the optimal state irrespective of the fluctuation in the power source Vₚ, the vibration in the waveform or the waveform rounding is prevented from occurring in each of the loop current transition portions, which makes it possible to exclude the bad influence exerted on the quality of the displayed image.

### SECOND EMBODIMENT

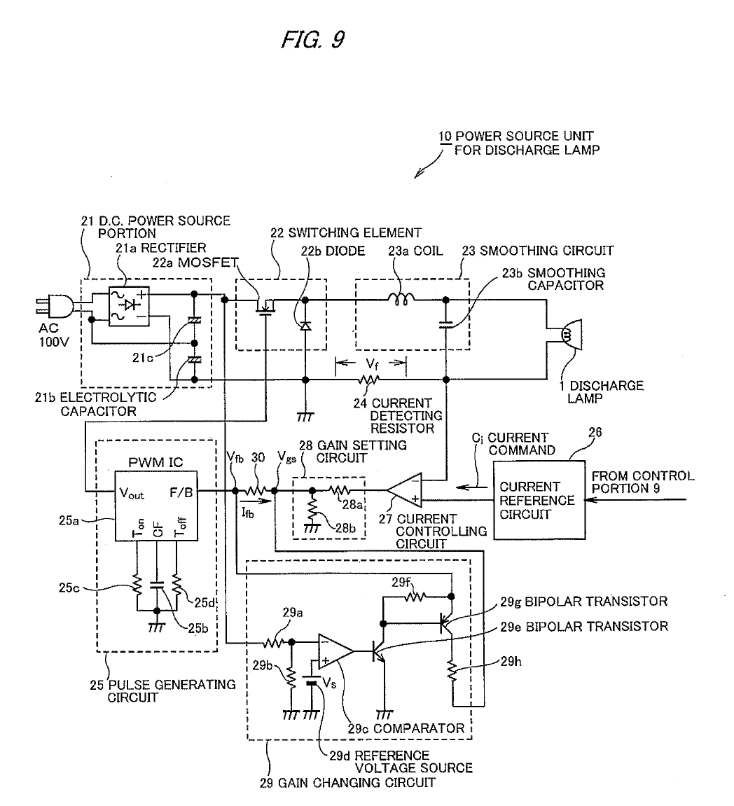

FIG. 9 shows a power source unit for a discharge lamp according to a second embodiment of the invention. The power source unit 10 for a discharge lamp of the second embodiment is different in circuit structure from the power source unit 10 for a discharge lamp of the first embodiment in that a resistor 30 is connected between the gain setting circuit 28 and the pulse generating circuit 25, so that other suitable resistor can be selectively connected in parallel with the resistor 30 in correspondence to the fluctuation in the power source voltage Vₚ. In addition, the image displaying apparatus having the power source unit 10 for a discharge lamp of this embodiment applied thereto is the same in construction as the image displaying apparatus 100 of the first embodiment shown in FIG. 1.

The gain changing circuit 29 of this embodiment is different in circuit structure from that of the first embodiment in that the form of the connection to the input terminals of the comparator 29c is reversed in polarity, a base of a PNP transistor 29g is connected to the collector of the NPN transistor 29e having the base connected to the output terminal of the comparator 29c, a resistor 29f is connected in parallel between an emitter and the base of the PNP transistor 29g, a collector of the PNP transistor 29g is connected to the output terminal of the gain setting circuit 28 through a resistor 29h, and also the emitter of the PNP transistor 29g is connected to the feedback terminal F/B of the pulse generating circuit 25.

While the power source voltage Vₚ is smaller than the reference voltage Vs in FIG. 9, the comparator 29c outputs the output signal, so that the NPN transistor 29e is held in the ON state. Therefore, a base voltage is applied to the base of the PNP transistor 29g through the NPN transistor 29e, so that the PNP transistor 29g is held in the ON state. While the PNP transistor 29g is held in the ON state, the resistor 29h is connected in parallel with the resistor 30. Therefore, the resistance value of the parallel-connected resistors 29h and 30 connected between the output terminal of the gain setting circuit 28 and the feedback terminal F/B of the PWMIC 25a is smaller than that of the resistor 30.

Next, when the power source voltage Vₚ exceeds the reference voltage Vₛ, the comparator 29c outputs no output voltage to turn OFF the NPN transistor 29e. As a result, the PNP transistor 29g is turned OFF, so that the connection of the resistor 29h to the resistor 30 becomes open, and thus the resistor connected between the output terminal of the gain setting circuit 28 and the feedback terminal F/B of the PWMIC 25a is constituted by only the resistor 30. As a result, the voltage value applied to the feedback terminal F/B is smaller in this case than in the case where the PNP transistor 29g is held in the ON state.

Here, a value I_{fb} of the current which is caused to flow out through the feedback terminal F/B while the PNP transistor 29g is held in the OFF state is expressed by Expression (4):

I_{fb}=(V_{fb}−V_{gs})/R30 . . . (4)

where V_{fb} is a voltage at the feedback terminal F/B, R30 is a resistance value of the resistor 30, and V_{gs} is an output voltage from the gain setting circuit 28.

On the other hand, the value I_{fb} of the current which is caused to flow out through the feedback terminal F/B while the PNP transistor 29g is held in the ON state is expressed by Expression (5):

I_{fb}=(V_{fb}−V_{gs})/(R30//R29h) . . . (5)

where R29h is a resistance value of the resistor 29h.

Here, the voltage V_{fb}, for example, is fixed to 5.9 V in the inside of the pulse generating circuit 25. When the voltage value of 5.9 V is substituted into V_{fb} in each of Expressions (4) and (5), the current value I_{fb} while the PNP transistor 29g is held in the OFF state is expressed by Expression (6):

I_{fb}=(5.9−V_{gs})/R30 . . . (6)

On the other hand, the current value I_{fb} while the PNP transistor 29g is held in the ON state is expressed by Expression (7):

I_{fb}=(5.9−V_{gs})/(R30//R29h) . . . (7)

An amount, ΔI_{fb}, of change in current value I_{fb} when the output voltage V_{gs} changes by a unit voltage ΔV_{gs} while the PNP transistor 29g is held in the OFF state is given as follows from Expression (6):

ΔI_{fb}=(5.9−ΔV_{gs})/R30 . . . (8)

On the other hand, an amount, ΔI_{fb}, of change in current value I_{fb} when the output voltage V_{gs} changes by the unit voltage ΔV_{gs} while the PNP transistor 29g is held in the OFF state is given as follows from Expression (7):

ΔI_{fb}=(5.9−ΔV_{gs})/(R30//R29h) . . . (9)

A comparison of Expression (8) with Expression (9) shows that the amount, ΔI_{fb}, of change in current value I_{fb} when the output voltage V_{gs} changes by the unit voltage ΔV_{gs} is larger in Expression (9) than in Expression (8). In other words, an amount of change in duty is larger in Expression (9) than in Expression (8). Therefore, when the PNP transistor 29g is turned OFF in accordance with an increase in power source voltage Vₚ, the amount of change in duty becomes small, so that the loop gain G is reduced, and thus no waveform disturbance occurs in each of the lamp current transition portions for the period, t, of time for a small lamp current.

According to the second embodiment of the invention, since the loop gain G is held in the optimal state irrespective of the fluctuation in the power source voltage Vₚ similarly to the first embodiment, it is possible to obtain the same effects as those in the first embodiment.

It should be noted that the invention is not intended to be limited to the above-mentioned first and second embodiments, and the various kinds of changes can be made by those skilled in the art without changing the gist of the invention. For example, the constituent elements of the first and second embodiments can be arbitrarily combined with one another.

For example, in each of the above-mentioned first and second embodiments, the lamp current caused to flow through the discharge lamp 1 is controlled for G (green) of the three primary colors R, G and B. However, the invention is not limited to the control for G, and thus can be applied to a discharge lamp having such characteristics that a specific light is not balanced with other lights having respective wavelength bands.

In addition, the circuit structures of the pulse generating circuit 25 and the gain changing circuit 29 shown in FIG. 2 are merely one example, and thus any suitable circuit structures may be adopted for the pulse generating circuit 25 and the gain changing circuit 29, respectively, as long as they exhibit the same functions as those shown in FIG. 2.

What is claimed is:

1. A power source unit for a discharge lamp, comprising:
a switching element for switching-driving the discharge lamp by using a D.C. power source as a power source;
a feedback control system for controlling the switching element in accordance with a detected lamp current value and a current command for the discharge lamp; and
gain changing means for changing a loop gain of the feedback control system in correspondence to a voltage fluctuation in the D.C. power source.

2. A power source unit for a discharge lamp according to claim 1, wherein the discharge lamp is a light source used for a projection type image displaying apparatus.

3. A power source unit for a discharge lamp according to claim 1, wherein the D.C. power source supplies a D.C. voltage from an A.C. power source, and is obtained from a constitution having no voltage stabilizing means.

4. A power source unit for a discharge lamp according to claim 1, wherein a lamp current caused to flow through the discharge lamp has a period of time for a large lamp current and a period of time for a small lamp current in accordance with a switching operation of the switching element.

5. A power source unit for a discharge lamp according to claim 4, wherein the period of time for a small lamp current of the lamp current is in a period of time for display of a green display color.

6. A power source unit for a discharge lamp, comprising:
a switching element for driving the discharge lamp by using a D.C. power source as a power source;
a smoothing circuit for smoothing an output from the switching element, and supplying the output thus smoothed to the discharge lamp;
current detecting means for detecting a current which is caused to flow through the discharge lamp;
a pulse generating circuit for switching the switching element at a high frequency in accordance with a difference between a preset current reference value and a value detected by the current detecting means; and
a gain changing circuit for changing a loop gain of a feedback control system including the switching element, the smoothing circuit, the discharge lamp, the current detecting means and the pulse generating circuit in correspondence to a voltage fluctuation in the D.C. power source.

7. A power source unit for a discharge lamp according to claim 6, wherein the discharge lamp is a light source used for a projection type image displaying apparatus.

8. A power source unit for a discharge lamp according to claim 6, wherein the D.C. power source supplies a D.C. voltage from an A.C. power source, and is obtained from a constitution having no voltage stabilizing means.

9. A power source unit for a discharge lamp according to claim 6, wherein the gain changing circuit reduces the loop gain when a voltage from the D.C. power source exceeds a set value.

10. A power source unit for a discharge lamp according to claim 6, wherein the gain changing circuit comprises:
a comparator for outputting an output signal when a voltage from the D.C. power source exceeds a set value; and
a transistor for, when the comparator outputs an output signal, reduces a level of a feedback signal inputted to the pulse generating circuit.

11. A power source unit for a discharge lamp according to claim 6, wherein the loop gain G of the feedback control system is expressed as follows:
G=G1×G2×G3
where G1 is a gain determined by the gain changing circuit, G2 is a gain determined by the smoothing circuit, and G3 is a gain determined by the pulse generating circuit, and
the gain G2 changes in conjunction with a fluctuation in the output voltage from the D.C. power source.

12. A power source unit for a discharge lamp according to claim 11, wherein the smoothing circuit is an LC smoothing circuit including a coil and a capacitor.

13. A power source unit for a discharge lamp according to claim 6, wherein a lamp current caused to flow through the discharge lamp has a period of time for a large lamp current and a period of time for a small lamp current in accordance with a switching operation of the switching element.

14. A power source unit for a discharge lamp according to claim 13, wherein the period of time for a small lamp current of the lamp current is in a period of time for display of a green display color.

15. A method of controlling a discharge lamp, comprising the steps of:
switching-driving the discharge lamp by a switching element by using a D.C. power source as a power source; controlling the switching element by a feedback control system in accordance with a detected lamp current value and a current command for the discharge lamp; and
changing a loop gain of the feedback control system in correspondence to a voltage fluctuation in the D.C. power source.

16. A method of controlling a discharge lamp according to claim 15, wherein the discharge lamp is a light source used for a projection type image displaying apparatus.

17. A method of controlling a discharge lamp according to claim 15, wherein the D.C. power source supplies a D.C. voltage from an A.C. power source, and is obtained from a constitution having no voltage stabilizing means.

18. A method of controlling a discharge lamp according to claim 15, wherein a lamp current caused to flow through the discharge lamp has a period of time for a large lamp current and a period of time for a small lamp current in accordance with a switching operation of the switching element.

19. A method of controlling a discharge lamp according to claim 18, wherein the period of time for a small lamp current of the lamp current is in a period of time for display of a green display color.
